(19) United States
(12) Patent Application Publication
(10) Pub. No.: US 2026/0050502 A1
(43) Pub. Date: Feb. 19, 2026

(54) METHOD AND APPARATUS FOR MONITORING NETWORK SYSTEM, AND COMPUTING DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Zhanyao ZHANG, Beijing (CN); Zhenjun SHAO, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 18/996,053

(22) PCT Filed: Apr. 28, 2023
(86) PCT No.: PCT/CN2023/091680

§ 371 Date: Jan. 17, 2025

(51) Int. Cl. G06F 11/00; H04L 43/08

(52) U.S. Cl. CPC G06F 11/004; H04L 43/08; G06F 2201/81

(57) ABSTRACT

Provided are a method and an apparatus for monitoring a network system, and a computing device. The network system includes at least one resource cluster. The method includes: in response to a health degree display triggering event, displaying a health degree of a monitored object on a first display interface, different health degrees corresponding to different marks, wherein the monitored object includes at least one of the following: the network system, one or more resource clusters in the at least one resource cluster, one or more resources included in the network system, or one or more services provided by the network system. The health degrees of various levels can be displayed, and a scientific basis can also be provided for the response time of the operation and maintenance personnel based on the different health degrees, so that rapid problem positioning can be achieved, thereby solving the management problem.

### TECHNICAL FIELD

The disclosure relates to the field of computers, and more particularly, to a method and an apparatus for monitoring a network system, a computing device and a medium.

### BACKGROUND

During the construction of large-scale projects such as industrial parks, a large-scale network system is involved. In this network system, a plurality of server (virtual machine or physical machine) clusters are involved to provide the resources needed by the network system, and containers, processes, ports, logs, plug-ins and so on (collectively referred to as the assets of the network system) are generally deployed or run on the servers to provide various services.

Usually, it is necessary to access respective assets in the network system to manage and monitor them, so as to evaluate the running status of respective asset nodes in the network system.

Due to the high complexity of the large-scale network system, including long network links, multi-level operating environment and various monitored objects, the traditional monitoring scheme monitors respective asset nodes in the network system in detail, so there are often a lot of alarms, and there is a lack of overall and scientific standards and algorithms for measuring the health degree of various levels (the health degree of systems, servers, services, etc.), that is, there is a lack of local and global perspectives, and there is also a lack of intuitive visual presentation manners. In addition, the large-scale network system involves many roles of staffs, such as for development, computer room operation and maintenance, equipment operation and maintenance, and application operation and maintenance. Staffs with different roles have different responsibilities and perspectives, and the staffs with different roles may only need to pay attention to specific types of monitored objects, so they have different requirements for grouping monitored objects.

Therefore, there is a need for a method that can monitor the network system, perform intuitive presentations and meet the personalized monitoring perspectives of different roles.

### SUMMARY

According to an aspect of the present disclosure, there is provided a method for monitoring a network system, which comprises at least one resource cluster, and the method comprises the following steps: presenting, in response to a health degree presentation trigger event, a health degree of a monitored object on a first display interface, wherein different health degrees correspond to different markers, wherein, the monitored object includes at least one of: the network system, one or more resource clusters among the at least one resource cluster, one or more resources included in the network system, or one or more services provided by the network system.

According to another aspect of the present disclosure, there is provided an apparatus for monitoring a network system, which comprises at least one resource cluster, and the apparatus comprises: a data acquisition module configured to acquire, from the network system and a public network to which the network system is connected, various indicator data related to a health degree of a monitored object; a monitoring server, comprising: a presentation management module configured to present, in response to a health degree presentation trigger event, the health degree of the monitored object on a first display interface, wherein different health degrees correspond to different markers, wherein, the monitored object includes at least one of: the network system, one or more resource clusters among the at least one resource cluster, one or more resources included in the network system, or one or more services provided by the network system.

According to another aspect of the present disclosure, there is provided a computing device comprising one or more processors and one or more memories, on which computer programs are stored, which, when executed by the one or more processors, may cause the one or more processors to implement the steps of the method as described above.

The embodiments of the present disclosure provide a solution for monitoring the network system. The concept of a health degree is put forward from the perspective of the end user. By designing the metric indicator model and algorithm of the health degree, respective levels of the health degree (for example, a comprehensive health degree of the network system, and a server cluster health degree, a server health degree, a service health degree, a public network portal health degree, etc., which are further detailed) can be finally presented. Based on different levels of health degrees, scientific basis for response time of operation and maintenance personnel can be provided, which can quickly locate issues and solve management problems.

### BRIEF DESCRIPTION OF DRAWINGS

In order to explain the principles of the present disclosure, embodiments of the present disclosure will be described in conjunction with the accompanying drawings. It should be understood that the elements shown in the figures may be implemented in various forms of hardware, software or combinations thereof. Alternatively, these elements are implemented in a combination of hardware and software on one or more appropriately programmed general-purpose computer devices.

FIG. 1 shows a schematic diagram of a monitoring scenario according to embodiments of the present disclosure.

FIG. 2 shows a schematic diagram of a resource configuration interface for realizing resource configuration according to the embodiments of the present disclosure.

FIG. 3 shows a schematic diagram of an alarm configuration interface for realizing alarm policy configuration according to the embodiments of the present disclosure.

FIG. 4 is a schematic diagram of an alarm detail interface according to the embodiments of the present disclosure.

FIG. 5 shows a schematic diagram of a health degree presentation interface showing health degree according to the embodiments of the present disclosure.

FIG. 6 shows a schematic diagram of a picture viewing display interface according to the embodiments of the present disclosure.

FIG. 7 shows a schematic diagram of a display interface including various indicator data values for a certain resource according to the embodiments of the present disclosure.

FIG. 8 shows a schematic diagram of a statistical data display interface according to the embodiments of the present disclosure.

FIG. 9 shows a flowchart of a method for monitoring a network system according to the embodiments of the present disclosure.

FIG. 10 shows a schematic diagram of a display interface which overlays the display interface shown in FIG. 5 and presents the indicator data values of a plurality of monitored indicators of the concerned resource cluster.

FIG. 11 shows a diagram of all monitored indicators required when calculating the comprehensive health degree of the network system according to the embodiments of the present disclosure.

FIG. 12 to FIG. 14 respectively show flowcharts for calculating the comprehensive health degree of the network system according to the embodiments of the present disclosure.

FIG. 15 shows a structural block diagram of an apparatus according to the embodiments of the present disclosure.

FIG. 16 shows a structural block diagram of a computing device according to the embodiments of the present disclosure.

### DETAILED DESCRIPTION

Embodiment of that the present disclosure will be described more fully hereinafter with reference to the accompany drawings, in which embodiments of the present disclosure are shown. However, the present disclosure may be embodied in many different forms and should not be construed as limited to the embodiments set forth herein. Throughout, like reference numerals are used to refer to like elements.

The terminology used herein is for the purpose of describing specific embodiments only and is not intended to limit the disclosure. As used herein, the singular forms “a” and “this” are intended to include the plural forms as well, unless the context clearly indicates otherwise. It should also be understood that the term “comprising”, when used herein, specifies the presence of stated features, integers, steps, operations, elements and/or components, but does not exclude the presence or addition of one or more other features, integers, steps, operations, elements, components and/or groups thereof.

Unless otherwise defined, terms (including technical terms and scientific terms) used herein have the same meaning as commonly understood by one of ordinary skill in the field to which this disclosure belongs. Terms used herein should be interpreted as having meanings consistent with their meanings in the context of this specification and related fields, and cannot be interpreted in an idealized or overly formal sense unless specifically defined herein.

As mentioned above, large-scale network systems are involved in the construction of large-scale projects such as industrial parks. By way of example, but not limitation, these large-scale projects can be applied to smart industrial parks, smart banks, smart transportations and other scenarios, thus involving a variety of types of businesses including: finding people in industrial parks, passenger flow statistics, parking lot management, license plate number recognition, face recognition, cross-border tracking, and warning tips. Each type of business is a service, corresponding to its own big data management, algorithm call and model interfaces, so the network systems used to provide these businesses or services each have a complex layout and needs to include a large number of network resources (for example, servers) to realize it. For example, for a smart industrial park, different departments or project teams may have respective groups of network resources, and/or different services provided (for example, face recognition service or parking space management service) are also provided by the respective groups of resources.

At the same time, the performance, running status and health degree of a network system and its various resources are very important to the final service or business. For example, if the performance of a group of resources providing the face recognition service is reduced and the service may not be provided normally, which may lead to the failure of access control, etc. Therefore, it is necessary to take the network system and its resources, resource clusters and/or services provided by the network system as monitored objects to monitor the real-time status of the network system. In addition, other asset nodes of the network system (containers, processes, ports, logs, plug-ins, etc. deployed or running on servers that provides resources) can be monitored as needed at the same time to assist in judging the status of the network system.

A traditional monitoring solution monitors each asset node in the network system in detail, so it often gives a lot of alarms, which lacks a local perspective and a global perspective. Further, the traditional monitoring solution also lacks intuitive visual presentation, and does not consider the different requirements, of staffs in different roles, for the grouping of monitored objects.

Therefore, the embodiments of the present disclosure provide a solution for monitoring a network system, which groups resources based on groups and/or labels, and both labels and groups can be set in multiple levels, thus satisfying requirements for personalized monitoring perspectives of different roles and/or departments, and realizing flexible grouping of resources. In addition, the embodiments of the present disclosure also put forward a concept of the health degree from the perspective of end user. By designing the metric indicator model and algorithm for the health degree, respective levels of the health degree can be finally presented (for example, the comprehensive health degree of the network system, and the server cluster health degree, the server health degree, the service health degree, and/or the public network portal health degree, etc., which are further detailed). Based on different levels of the health degree, scientific basis for response time of operation and maintenance personnel can be provided, which can quickly locate issues and solve management problems. In addition, in addition to presenting the health degree, other collected indicators of the network system can be presented in different manners, and statistical data for indicator data of the resources of the network system can also be presented, and so on.

In the context of the present disclosure, resources refer to hardware and software configurations that can be provided by a server(s) (physical machine and/or virtual machine) to realize various functions of the network system, for example, to various processing devices (such as CPU, MCU, DSP, ASIC, etc.) and various storage devices (such as memory or disk, etc.) in the server(s). Therefore, for the convenience of description, in some places in the present disclosure, resources can be equated or used interchangeably with servers.

In the context of the present disclosure, the performance, running status and health degree of each monitored object (such as resources, resource clusters, services, the public network portal, etc.) in the network system depend on corresponding influencing factors, and these influencing factors can be reflected or measured by corresponding indicators, so the performance, running status and health degree of the monitored object can be determined by collecting data values of the indicators.

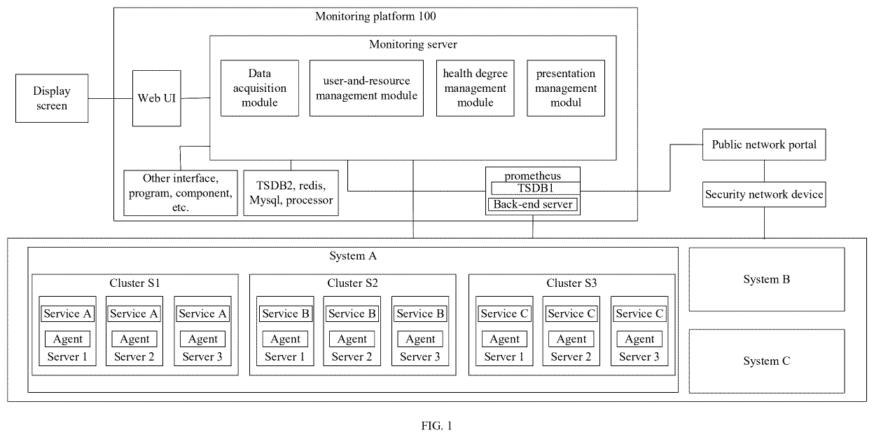

Hereinafter, the solution for monitoring the network system according to the embodiments of the present disclosure will be described in detail with reference to FIG. 1 to FIG. 16.

FIG. 1 shows a schematic diagram of a monitoring scenario according to the embodiments of the present disclosure.

FIG. 1 shows a schematic scene in which a monitoring platform 100 is used to monitor a plurality of network systems (for example, set in a same industrial park), which are represented by system A, system B and system N respectively. Although only three network systems are shown in FIG. 1, it should be understood that more or less network systems are possible, and the following similar expressions can also be understood as such.

The monitoring solution used for the network system in the present disclosure can be carried out for each network system, that is, the monitoring of each network system is independent. At the same time, when it is necessary to determine a system health degree for all systems according to monitored data, a comprehensive system health degree for all network systems can also be determined according to the calculated system health degree for each network system.

As shown in FIG. 1, system A may include a plurality of server clusters (represented by cluster S1, cluster S2 and cluster S2 respectively), each of which includes the same or different numbers of servers. In the present disclosure, resources usually refer to servers, so server clusters can also be referred to as resource clusters. In the present disclosure, each server may be a cloud server, a local server, a physical server or a virtual server, which is not limited in the present disclosure. Each server is the basis for providing services, so the server can be regarded as a resource(s).

Optionally, the server clusters are obtained by grouping a plurality of servers in the network system according to the deployed service types. For example, each server (resource) is provided with a resource label associated with a service type, so that the server cluster providing a certain type of services can be determined through the resource label, and meanwhile, the server cluster is also called a service cluster. In addition, server clusters can also be achieved by grouping multiple servers in the network system according to whether they belong to a same organization or whether they belong to same operating environment. For example, multiple servers can be grouped according to at least one dimension of: department, project and environment, and then, each server cluster may provide multiple services.

A plurality of network systems (system A, system B, system N) in FIG. 1 can be connected to a public network, for example, connected to a public network portal via a secure connection network device, so as to perform data communication with the public network.

The monitoring platform 100 may include a monitoring server, a storage device (e.g., TSDB2), a processor, a database (such as redis and mysql), plug-ins, interfaces, programs, interface display components (such as Web UI), etc. Optionally, the monitoring server may include at least a part of the storage device, the processor and the database, and may alternatively or additionally include additional processors and storage devices, etc. for realizing the functions of each module (e.g., data acquisition module, or health degree management module as shown). In addition, the monitoring platform can also be connected with a display screen, which is used to show various display interfaces. In the present disclosure, various display interfaces can refer to content presentation pages that can provide contents to users, including web pages, client interfaces and the like. The monitoring server can call various interfaces to obtain data from outside. The monitoring platform 100 is used to collect various indicator data of the network system, and can process, analyze, calculate, present the collected indicator data, or perform other operations on the collected indicator data.

For example, when collecting the indicator data of servers in a network system (for example, servers 1/2/3 in FIG. 1), an agent program (Agent) can be deployed on each server of the network system to collect the indicator data of the server, including related data of the network, central processing unit (CPU), memory/disk, etc., and then the agent program will transfer the indicator data of the server to the monitoring server of the monitoring platform (for example, through a message queue or a remotely called push mode) and it can be stored in the corresponding storage device (for example, TSDB2). The collected indicator data of various indicators is stored in the storage device in a predetermined data format.

For another example, when collecting the indicator data of the services provided by the network system, different output plug-ins (Exporter) can be deployed according to different types of services. In some cases, the output plug-ins are deployed separately, while in other cases, they are bound with corresponding services. Then, the Prometheus program at the monitoring platform grabs data and stores it into the corresponding storage device (such as TSDB1) through http services exposed by various services, and then the monitoring server of the monitoring platform calls Prometheus interface through http protocol to transfer the monitored service-related data from the storage device (such as TSDB1) to TSDB2.

In addition, for other indicator data of other monitored objects of the network system (for example, containers, logs, processes, etc. on the server), corresponding programs, interfaces, etc. can be similarly deployed on the monitoring platform to obtain corresponding indicator data in cooperation with programs, components, etc. at the monitored objects.

In addition, the monitoring platform 100 can also obtain the indicator data of the public network portal, for example, indicator data related to connectivity and bandwidth utilization rate. For example, the collection manner of the indicator data of the public network portal can be similar to that of the services, for example, it can be collected by a special agent or plug-in arranged at the public network portal, and then the monitoring server obtains the collected data from it.

The monitoring server or other processors of the monitoring platform 100 can process, analyze, calculate, present the collected indicator data, or perform other operations on the collected indicator data.

For example, the monitoring server of the monitoring platform may include a data acquisition module, a user-and-resource management module, an alarm management module, a health degree management module, and a presentation management module (for example, it can be further divided into a picture viewing module, a large-cap monitoring module, and a large-screen presentation management module, etc.). In addition to the monitoring server, the monitoring platform may also include other plug-ins, interfaces, programs, etc. to facilitate data interaction with the outside. Data between modules can be transferred to each other, and at least a part of each module can be combined into another module, or can be further divided into more modules. Each module can be realized by combining at least a part of hardware of the monitoring server included in the monitoring platform with corresponding programs or instructions stored therein. For example, each module can be implemented by a processor and a computer program stored on a memory. The processor can be, for example, a general processor, a digital signal processor (DSP), an application specific integrated circuit (ASIC), a field programmable gate array (FPGA) or other programmable logic devices, discrete gate or transistor logic devices, or discrete hardware components. The general processor can be a microprocessor or any conventional processor, and it can be X84 architecture or ARM architecture. The memory may include read-only memory (ROM), programmable read-only memory (PROM), erasable programmable read-only memory (EPROM), electrically erasable programmable read-only memory (EEPROM) or flash memory, etc. It should be noted that the memory of the present disclosure is intended to include, but is not limited to, these and any other suitable types of memory.

The data acquisition module can acquire the indicator data collected by the above method for each monitored object and public network portal, etc. The user-and-resource management module is used to realize user registration and role grouping, and grouping of various resources (for example, various servers) in the network system. The alarm management module is used to realize timely notification when an alarm event occurs. The health degree management module is used to determine health degrees of respective levels of the system or the health degree of the public network portal, etc. The presentation management module can be used in a procedure of user interaction and/or a procedure of processing information or data input by users, can generate display data (graphics, images, words or charts, etc.) of various health degrees of the network system, various indicator data and various statistical data of the whole network system, and can cooperate with UI components to present to users on the display interface of the display screen. In addition, the monitoring platform 100 may also provide functions for users to perform various configuration operations (for example, resource management configuration, or alarm configuration, etc., which will be described later). For example, the presentation management module can also present corresponding configuration interfaces to the user on the display interface of the display screen, so that the user can input information on the configuration interfaces, and then the presentation management module processes the information input by the user.

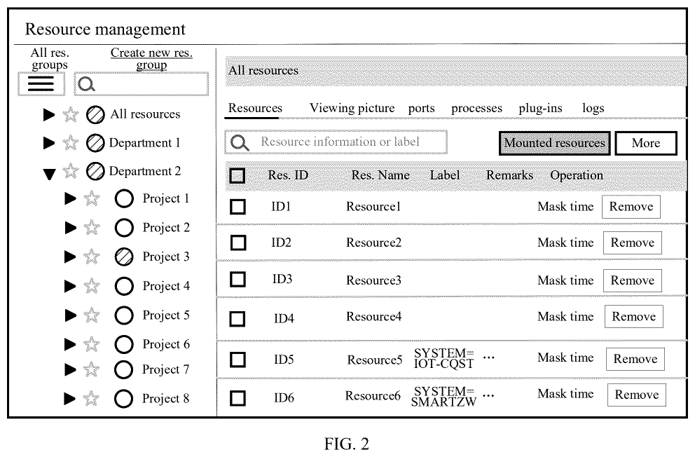

For the convenience of explanation, FIG. 2 shows a schematic diagram in which the presentation management module cooperates with the user-and-resource management module to realize resource management. It should be noted that it only lists modules that mainly execute the process, and it does not exclude that other related modules also execute the process together.

As shown in FIG. 2, a resource configuration interface (a user has successfully logged in) is shown on the display screen, which can be in the form of a web page or a client interface. In response to the user's operation (for example, through an external input device such as a mouse, keyboard or trackball, etc. or the user touching an option on the screen, etc.), resource groups are first created, and then each resource is included in a corresponding resource group. The left column of the resource configuration interface may show a list of various resource groups that have been created. In response to the user's selection operation, resources in the selected resource group can be presented on the resource configuration interface. For example, grouping can be performed based on at least one dimension of: department, project and operating environment.

Optionally, when presenting respective resources, the resource configuration interface may also present information of each resource (including resource identification, resource name, etc.). Optionally, each resource may also be configured with one or more resource labels (in a form of key=value) for logical grouping, so that resources that may not belong to the same department or project can be screened out as a resource group through the resource label(s). For example, resource labels may be configured according to service types for which resources are deployed.

Optionally, the monitoring platform can also realize an operation of viewing pictures related to resources or resource clusters (e.g., presenting indicator data values of the resources or resource clusters in a form of charts, etc.) and/or can obtain contents of ports, processes, plug-ins and logs and/or the like on the server, so that the resource configuration interface not only presents information on resource groups, a trigger prompt (for example, the trigger prompt can be a text icon, etc.) can also be presented for triggering the presentation operation of viewing pictures (e.g., presenting indicator data values of the resources or resource clusters in a form of charts, etc.), ports, processes, plug-ins, logs, etc. related to the resources or resource clusters, so that the monitoring platform can also respond to respective presentation trigger events (for example, respond to the user's click operation on a corresponding icon or location area, for example, the user's click operation on the text icon “viewing pictures” shown in FIG. 2), and accordingly present related contents that have been acquired or processed.

Alternatively, contents on the resource configuration interface shown in FIG. 2 can be switched based on the user's operation (for example, the user slides a slider or drags the slider up or down (not shown) for a display region of a resource group, etc.), for example, in a case of a small display screen.

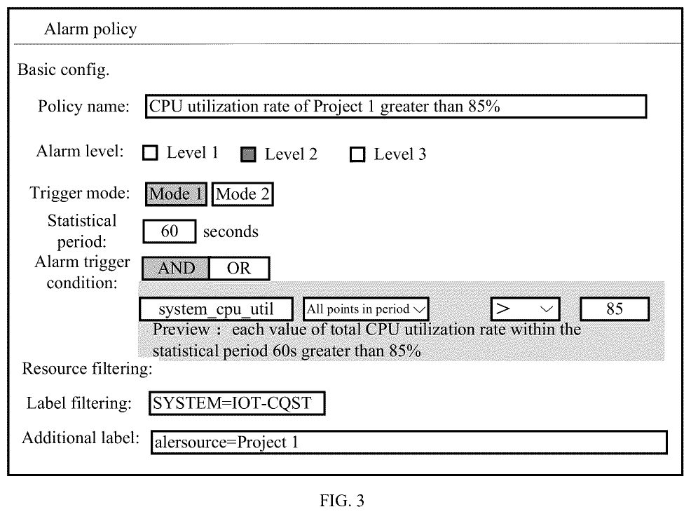

In addition, FIG. 3 shows a schematic diagram that the presentation management module cooperates with the alarm management module to realize an alarm policy configuration.

As shown in FIG. 3, an alarm configuration interface is presented on the display screen, which may include a plurality of input boxes or selection boxes for users to input or select information such as alarm policy name, alarm level, trigger mode, statistical period, alarm trigger condition (supporting logical operators, functions, comparison operators, etc.), or resource filtering, notification manner and recipients, etc., so as to form an alarm policy for predetermined resources.

Here, it is shown that resources or resource clusters with a predetermined label can be screened out from resources of the network system based on label-based filtering, and then a corresponding alarm policy can be set for the resources or resource clusters with the predetermined label, that is, alarm policies may be different for different resources or resource clusters. For example, the alarm policy for a certain resource or a certain resource cluster or even for the whole network system can be set through different label settings.

For example, FIG. 3 schematically shows that the alarm policy is targeted at a resource cluster of Project 1, and the alarm level is a level-2 alarm. The targeted resource cluster can be filtered by the label SYSTEM=IOT−CQST (for example, a resource label according to the service type) and an additional label indicating an organization to which the resource belongs. In addition, since the alarm policy here is targeted at the resources of Project 1, the additional label alersource=Project 1 is set. That is to say, when all the values of a total CPU utilization rate for these resources (for example, an average rate of their respective CPU utilization rates) in the resource cluster of Project 1 with the label SYSTEM=IOT−CQST exceed 85% within a statistical period (for example, 60 s), it is determined that the alarm triggering condition is met, so that the trigger can be made according to Mode 1 (for example, the trigger may include a nightingale trigger mode or a prometheus trigger mode). Alternatively, it can also be configured to determine that the alarm trigger condition is met when any value of the total CPU utilization rate for these resources exceeds 85% in the statistical period (for example, 60 s), which can be realized based on a happen function, so that the trigger can be made. Optionally, when configuring the alarm policy, information of the recipients of an alarm notification can be additionally configured.

Alternatively, contents on the alarm configuration interface shown in FIG. 3 can be switched based on the user's operation (for example, the user slides a slider or drags the slider up or down (not shown) for a display region, etc.), for example, in a case of a small display screen. Optionally, the alarm management module can also cooperate with the health degree management module, so that when an alarm event occurs and it is necessary to send the alarm notification to the recipients, the health degree of the resource or resource cluster or the comprehensive health degree of the network system (the health degree calculation method for the comprehensive health degree will be described later) targeted by the alarm event is further attached to the alarm notification, so that the operation and maintenance personnel can know the overall situation of the resource or resource cluster or the network system targeted by the alarm event.

In addition, the presentation management module can also cooperate with the alarm management module to present alarm details when the alarm trigger condition is met.

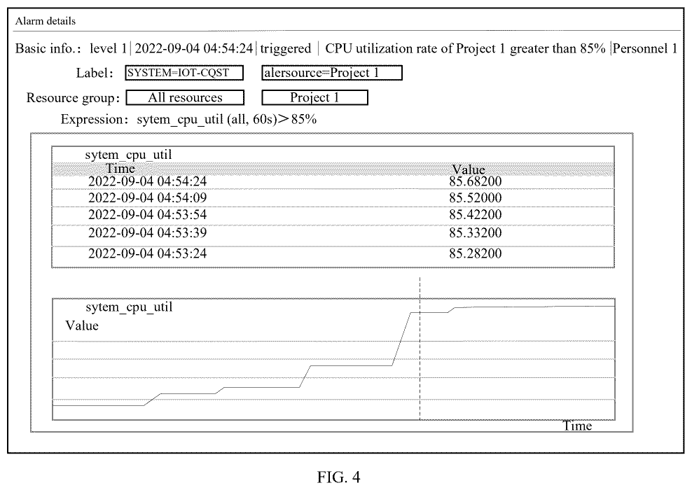

As shown in FIG. 4, an alarm detail interface is presented on the display screen. Optionally, the alarm detail interface may correspond to the configured alarm policy shown in FIG. 3.

Assuming that indicator data values of a monitored indicator of the targeted resource cluster meet the alarm trigger condition (for example, the overall CPU utilization rate for the resource cluster exceeds 85% within the statistical period (for example, 60 s), the alarm details are presented on the display interface, which may include information of the alarm trigger condition, the indicator data value meeting the alarm trigger condition and related information of the targeted resource cluster.

For example, in the upper part of FIG. 4, basic information of a current alarm event (for example, an alarm level, an event occurrence time, whether triggering is completed, and information of personnel to be notified), an expression of the alarm trigger condition, and label information and grouping information of resource clusters that meet the alarm trigger condition (the resource clusters may belong to multiple groups), etc. are shown.

In addition, in the lower part of FIG. 4, information of indicator data values that meet the alarm trigger condition for the targeted resource cluster is shown. Specifically, the information of these indicator data values is shown in a form of list and chart respectively. For example, when presented in the form of list, the indicator data values at the time points of multiple alarm events (for example, the overall CPU utilization rate for the resource cluster exceeds 85% within the statistical period (for example, 60 s)) are shown according to a time sequence of these alarm events. When presented in the form of chart, the indicator data values within a predetermined time period can be presented in a time line, and a reminder mark (for example, a vertical dotted line) can be presented at a time point when the alarm event occurs for the first time.

Alternatively, contents on the alarm detail interface shown in FIG. 4 can be switched based on the user's operation (for example, the user slides a slider or drags the slider up or down (not shown) for a display region, etc.), for example, in a case of a small display screen. In addition, the presentation management module can also cooperate with the health degree management module to present the health degree of the monitored object (resources, resource clusters, provided services or network system).

The calculation method of the health degree will be described in detail later. The health degree management module can calculate the health degree based on indicator data values of respective monitored indicators (corresponding to respective influence factors related to the performance or running status of the targeted resource or resource cluster) collected by the data acquisition module, and then the presentation management module can present the health degree, so that the running status of the monitored object can be intuitively presented on the display interface. For example, the presentation management module can determine corresponding RGB values according to the current health degree calculated by the health degree management module, and present the current health degree with the color corresponding to the determined RGB values.

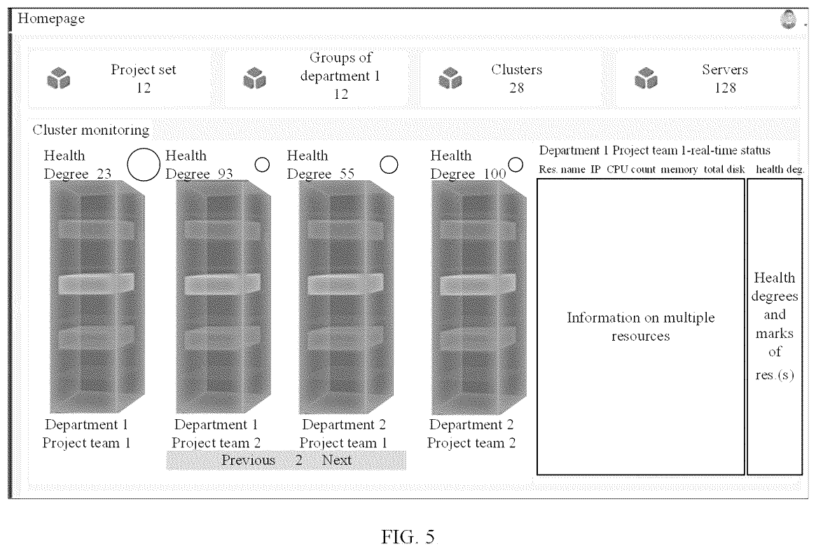

FIG. 5 shows a schematic diagram of a health degree presentation interface showing the health degree.

As shown in FIG. 5, the health degree presentation interface shows the health degrees of four resource clusters, which can be grouped based on organizations they belong to, and can respectively correspond to resources included in project team 1 of department 1, project team 1 of department 2, project team 2 of department 1 and project team 2 of department 2. These four resource clusters have different health degrees (for example, 23, 93, 55 and 100 points on a scale of 100 points) and can be presented in different colors.

In addition, on the right side of the health degree presentation interface, the real-time status of the resource cluster (a concerned resource cluster) corresponding to the project team 1 of the department 1 is also shown, that is, the health degrees of respective resources in the resource cluster are shown (for example, using numerical values with markers plus different colors or using markers of different graphic shapes, etc.), and in addition, more information of the server corresponding to each resource can be shown, such as server identification, IP address, CPU check count, memory, total disk size, etc.

In addition, the network system may include a large number of resource clusters, and the health degree presentation interface may only show the health degrees of some of the resource clusters at a time, so the health degree presentation interface may also provide an interface for a user to input switching information, for example, the user can slide in a region presenting the health degrees of resource clusters or click an interface element indicating switching at the bottom of the region.

In addition, in order to make the user have a more comprehensive understanding of various resources of the network system and their groupings, a total number of resource clusters of the network system (for example, 28 clusters) and a total number of resources (servers) (for example, 128 servers) can also be presented on the health degree presentation interface.

Alternatively, the contents on the health degree presentation interface shown in FIG. 5 can be switched by the user's operation (for example, the user slides a slider (not shown) or drags the slider up or down for the display region, etc.). In addition, when presenting in a form of a webpage, the real-time status of the concerned resource cluster on the right side of FIG. 5 can be independently presented on another page (another display interface) different from a display page (a first display interface) for the health degrees of the resource clusters. In addition, the picture viewing module in the presentation management module can also cooperate with the user-and-resource management module, and the data acquisition module to present indicator data values of a certain monitored indicator for some resources within a predetermined time period, so that it can be used for fault investigation and analysis.

For example, a picture viewing display interface may be presented in response to a user's input (for example, the user may click on the picture viewing icon as shown in FIG. 2). The user can input information indicating the resources to be viewed on the picture viewing display interface. For example, the resources to be viewed can be filtered according to three dimensions of an indicator name, a resource label and a time period, so that the indicator data values of a certain monitored indicator for a certain resource cluster within a certain time period can be viewed through the picture viewing display interface. Of course, the resources to be viewed may also be filtered according to the indicator name, a resource grouping identification and the time period.

Alternatively, the indicator data values of the monitored indicator of respective resources in the filtered resource cluster within the predetermined time period can be presented in the form of a graph (e.g., curves).

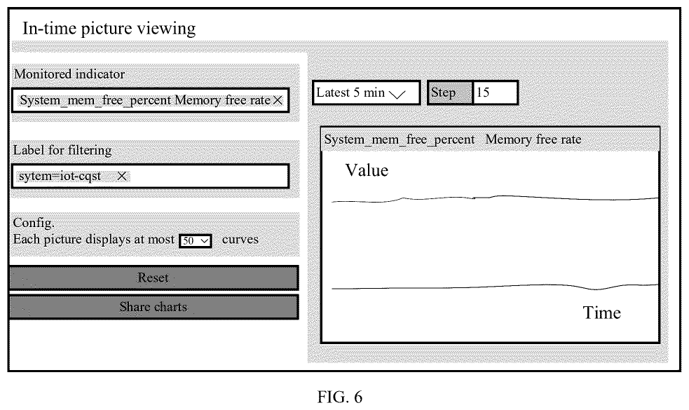

As shown in FIG. 6, the picture viewing module of the presentation management module can present a picture viewing display interface for the user to input information of the monitored indicator and the time period after processing the received input information. For example, the picture viewing display interface can be presented in response to a selection operation for a “picture viewing” text icon shown in FIG. 2 or other ways to trigger the presentation, where an input box or a selection box for the user to input can be presented on the picture viewing display interface, so as to allow the user to input the information of the monitored indicator name, the resource label and the time period, and additionally a number of curves that can be presented in each picture, where each curve represents the change of the indicator data value of one resource within the time period.

The picture viewing module can respond to the indication information input by the user for indicating the desired monitored indicator, the desired resource label (the indicated resource cluster is the desired monitored object) and the desired time period, and after processing the indication information, the indicator data values of the desired monitored indicator for the resources in the resource cluster corresponding to the desired resource label within the desired time period can be presented on the picture viewing display interface. For example, as shown in FIG. 6, two curves indicating that the memory idle rate (the indicator data value of the desired monitored indicator) of two resources (filtered by the desired resource label) changes with time within the desired time period are shown.

Similarly, the contents on the picture viewing display interface shown in FIG. 6 can be switched by the user's operation, that is, all the contents shown in FIG. 6 may not be presented at the same time. For example, an input box or a selection box for the user to input can be presented first in response to the user's operation and to processing on the operation, and then in response to a subsequent user's operation and to processing on the operation, the change in the indicator data values of respective resources within the desired time period can be presented, or the change in the indicator data values can be presented on another page when presented in the form of a webpage.

In addition, the large-cap monitoring module in the presentation management module can also cooperate with the data acquisition module, and the user-and-resource management module to present the indicator data values of various indicators of a certain monitored object (for example, a resource, a resource cluster and a service) and/or containers and middleware.

FIG. 7 shows a display interface of the indicator data values of various indicators for a certain resource (server).

As shown in FIG. 7, the indicator data values of respective indicators (shown as an average system load related to a system load indicator, and a CPU utilization rate and a percentage of CPU usage time in user mode related to a CPU indicator, other indicators can be included additionally or alternatively) of a predetermined resource (for example, designated by a resource identification or IP address) within a predetermined time period are shown in four charts. In this way, all indicators of this resource can be comprehensively presented. Alternatively, before the indicator data values of the selected resource are presented, for example, in response to a user's operation for viewing the indicator data values of the resource (such as the user inputting or selecting the resource identification of the desired resource on the interface shown in FIG. 7 (for example, the IP address of the server resource shown in the figure), or inputting indication information for indicating the desired resource (for example, resource ID or resource name, etc.) on the interface shown in FIG. 2, for example, clicking the “ID 1” or “Resource 1” text icon in FIG. 2, etc.). After data processing, the indicator data values of one or more monitored indicators of the desired resource are presented on the display interface shown in FIG. 7. In other examples, the display interface can also provide different ways for the user to input the indication information of the desired monitored object to monitor various indicators of other types of monitored objects (such as resource clusters).

Similarly, the contents on the display interface shown in FIG. 7 can be switched by a user's operation (for example, the user slides a slider (not shown) or drags the slider up or down for the display region, etc.). For example, the first two charts can be presented first, and then the remaining charts can be presented in response to the user's downward sliding operation. Similarly, these contents can also be presented on different webpages (display interfaces).

In addition, a large-screen presentation management module in the presentation management module can also cooperate with the data acquisition module and the user-and-resource management module to perform statistics on and/or present the indicator data values of various indicators of multiple monitored objects (for example, resources, resource clusters, services, containers, middleware, etc.) targeted by the monitoring platform and a number related to the resources of the network system, so as to conduct data statistics from a perspective of the whole monitoring platform.

Alternatively, the large-screen presentation management module can present statistical data on a display screen different from the display screen used to present the aforementioned various display interfaces.

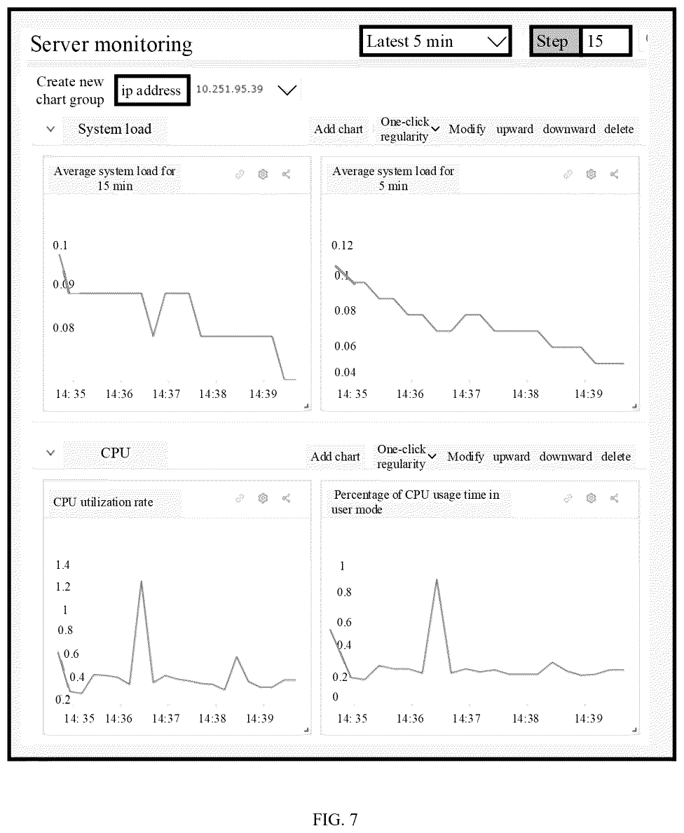

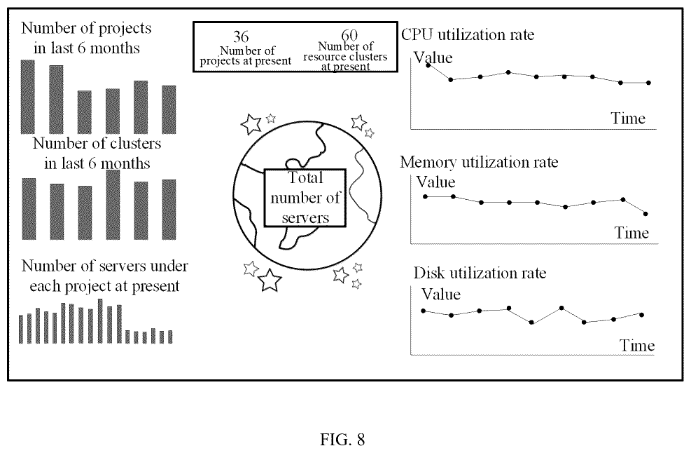

FIG. 8 shows a display interface for presenting the statistical data, in which the statistical data can include: a total number of projects in the last six months and a number of projects in each month, a total number of resource clusters in the last six months and a number of resource clusters in each month, a number of servers under each project at present, a total number of servers, a number of projects at present, a number of resource clusters at present, an overall CPU utilization rate at each of recent multiple time points, an overall memory utilization rate at each of recent multiple time points and an overall disk utilization rate at each of recent multiple time points. Of course, the contents of the statistical data can be preset, and types of the pieces of statistical data shown in FIG. 8 can be increased, decreased or changed.

Similarly, the contents on the display interface shown in FIG. 8 can be switched by a user's operation (for example, the user slides a slider (not shown) or drags the slider up or down for the display region, etc.).

Optionally, the above-mentioned project-related number, resource cluster-related number and server-related number can be obtained from the user-and-resource management module, and various overall utilization rates can be an average of corresponding acquired utilization rates of all servers obtained by the data acquisition module. For example, as shown in FIG. 7, the CPU utilization rate of one server at multiple time points can be obtained, and the overall CPU utilization rate shown in FIG. 8 can be obtained by obtaining the utilization rates of all servers at multiple time points and averaging them respectively.

Through the monitoring platform for monitoring the network system described with reference to FIG. 1-FIG. 8, different resources of the network system can be grouped and monitored from different perspectives, for example, respective resources can be grouped according to the resource label or the organization to which they belong, so that each resource can correspond to multiple resource clusters according to the grouping manner, so that the resource clusters to be monitored can be filtered according to actual needs, and the personalized monitoring perspectives of different roles and organizations can be realized. In addition, different contents can be presented through the presentation management module, and the contents of resources that need to be presented can be filtered. Further, the concept of the health degree is also put forward, which can intuitively provide the indication of the performance, running status or health degree of the network system, resources, resource clusters or services from the perspective of end users, and realize the monitoring of the network system from a local perspective and a global perspective.

A method for monitoring a network system according to the embodiments of the present disclosure is described below. The method may be performed by a monitoring platform (including a monitoring server, for example) described with reference to FIG. 1 to FIG. 8.

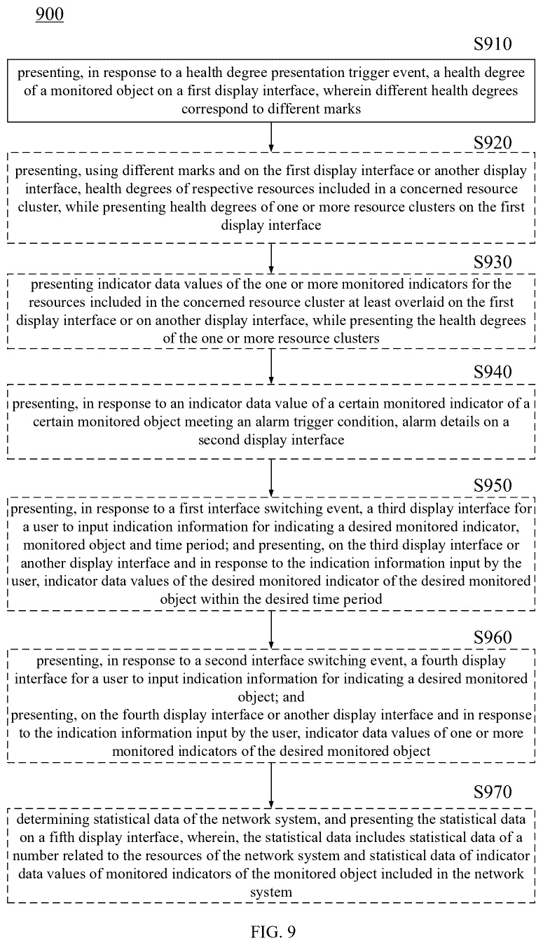

FIG. 9 shows a flowchart of a method for monitoring a network system according to the embodiments of the present disclosure. The network system may be one shown in FIG. 1 (for example, system A), which may include at least one resource cluster.

Optionally, the at least one resource cluster is obtained by grouping resources included in the network system by the user-and-resource management module, and the resources included in each resource cluster have a same resource label, or belong to a same organization, or have a same operating environment.

As shown in FIG. 9, in step S910, a health degree of a monitored object is presented on a first display interface, in response to a health degree presentation trigger event, where different health degrees correspond to different marks. The monitored object may include at least one of the following: the network system, one or more resource clusters among the at least one resource cluster, one or more resources included in the network system, or one or more services provided by the network system.

For example, a related health degree can be calculated for each resource, each resource cluster, the network system, each service, a public network portal, etc., and as will be described later for the health degree calculation method, the health degree of the resource cluster can be calculated based on the health degree of each resource included therein, the service health degree can be calculated from the health degree of the related resource or resource cluster providing services, and a comprehensive health degree of the network system can be calculated based on the service health degree and the public network portal health degree.

That is to say, the embodiments of the present disclosure can calculate various health degrees of different levels, and can present different health degrees on the first display interface according to actual needs.

For example, this step can be performed by the user-and-resource management module, the health degree management module and the presentation management module shown in FIG. 1. The health degree management module of the monitoring platform has calculated the health degree of the monitored object based on the indicator data value of the monitored object obtained by the data acquisition module, so if the presentation management module determines that the health degree presentation trigger event occurs, for example, upon receiving a user's input (e.g., the user touching or selecting through an input device a presentation trigger button presented on the display interface, double-clicking or long-pressing a current display region, sliding on the current display region and/or other actions), responding to startup of the monitoring platform or responding to presenting a webpage, etc., a processor corresponding to the presentation management module controls the operation of UI components to present the calculated health degree on the display interface of the display screen.

Alternatively, due to a limited size of the display interface, the health degrees of a part of monitored objects may only be presented at one time, so the health degrees of other monitored objects can also be displayed on a switched display interface in response to an interface switching event (for example, a user's sliding operation or clicking operation being detected).

In addition, because there may be differences between the health degrees of the monitored objects, different marks (for example, different colors, different font sizes, different shapes or sizes, etc.) can be used to present different health degrees.

Optionally, the health degree management module can also respond to a determination that the health degree of a certain monitored object does not meet a qualification threshold condition, and thus a reminder sign is presented while presenting the health degree of the monitored object such as a resource cluster, for example, a graphic is presented beside the presented health degree, the font or graphic size of the presented health degree is adjusted or a border is added to the presented health degree, etc.

Optionally, in step S920, health degrees of respective resources included in a concerned resource cluster of one or more resource clusters among the at least one resource cluster is presented using different marks and on the first display interface or another display interface, while presenting health degrees of the one or more resource clusters on the first display interface.

Generally, in the health degree calculation method to be described later, the health degree management module, when calculating the health degree of each resource cluster, needs to calculate the health degree of each resource in the resource cluster, that is, the health degree management module will also calculate the health degrees of respective resources in the resource cluster. Moreover, the health degrees of respective resources in the concerned resource cluster can be similarly presented with different marks (e.g., different colors) on the first display interface or another display interface. For example, the method may further include: determining, by the presentation management module, a corresponding mark from a plurality of candidate marks according to the health degree calculated by the health degree management module, and presenting the health degree with the determined mark. For example, a plurality of threshold ranges can be set in advance, and different threshold ranges correspond to different marks, thus a plurality of candidate marks are set, and then the mark corresponding to the calculated health degree can be determined according to the threshold range where the calculated health degree is located.

When different colors are used to show different health degrees, RGB values can be used to represent various colors. Then, the method can include: determining RGB values based on a current health degree of the monitored object to be presented; and presenting the current health degree with a color corresponding to the determined RGB values. RGB color is the color representing three channels of red, green and blue. This standard includes almost all colors that human vision can perceive, and it is one of the most widely used color systems at present. In addition to determining the color corresponding to the current health degree based on determining the threshold range where the current health degree is located (each threshold range corresponds to a color with preset RGB values), the RGB values corresponding to the current health degree can be determined by RGB (255*(1−SA), 255*SA, 0) instead, and the health degree SA is a value between 0 and 1. The current health degree is presented by using the color corresponding to the determined RGB values, so that the RGB values can be calculated for any health degree through a simple formula without setting a correspondence relationship between threshold ranges and colors in advance.

Optionally, a number of concerned resource clusters may be one or more.

Optionally, the concerned resource cluster may be a resource cluster whose health degree does not meet the qualification threshold condition among one or more currently presented resource clusters, the resource cluster whose health degree is the lowest among the one or more currently presented resource clusters, the resource cluster in which a number of resources whose health degree does not meet the qualification threshold condition exceeds a quantity threshold, or a resource cluster determined in response to a user's selection, etc. The determination manner of the concerned resource cluster is not limited in the present disclosure.

The schematic diagram of the first display interface can be shown in FIG. 5, in which the monitored object is a resource cluster as an example. As shown in FIG. 5, the first display interface shows the health degrees of four resource clusters, which can be grouped by the organization to which each resource belongs, and can respectively correspond to the resources included in project team 1 of department 1, project team 1 of department 2, project team 2 of department 1 and project team 2 of department 2. These four resource clusters have different health degrees (for example, 23, 93, 55 and 100 points on a scale of 100) and can be presented in different colors.

In addition, on the right side of the first display interface, the real-time status of the resource cluster (the concerned resource cluster) corresponding to the project team 1 of the department 1 is also shown, that is, the health degrees of respective resources in the resource cluster are shown (for example, each numerical value is marked with a color), and additionally, more information of the server corresponding to each resource can be shown, such as server identification, IP address, CPU check count, memory, total disk size and so on. Of course, as mentioned above, the real-time status (for example, health degree) of the concerned resource cluster can be presented on another display interface.

In addition, the network system may include a large number of resource clusters, and the first display interface may only show the health degree of some of the resource clusters at one time, so the first display interface may also provide an interface for a user to input switching information, for example, the user can slide in the display region presenting the health degrees of resource clusters or click on the interface element indicating switching at the bottom of the display region.

In addition, in order to make the user have a more comprehensive understanding of various resources and their groupings of the network system, the total number of resource clusters of the network system (for example, 28 clusters) and the total number of resources (servers) (for example, 128 servers) can also be displayed on the first display interface or another display interface.

It can be seen that by this method, when monitoring the network system, the health degree of the monitored object can be calculated and presented, so that the user can intuitively see the health degree of each monitored object, and can quickly locate the monitored object with a low health degree according to the health degree. When the monitored object is a resource cluster, the health degree and information of each resource in the resource cluster can also be presented, and the resource with a low health degree can also be quickly located.

Optionally, in order to more comprehensively present the collected various indicator data of the concerned resource cluster, the method may further include step S930. In step S930, while presenting the health degrees of one or more resource clusters, the indicator data values of one or more monitored indicators for the resources included in the concerned resource cluster are presented at least on the first display interface or on another display interface. For example, the presentation can be in response to a user's selection operation for the concerned resource cluster.

For example, for each resource cluster, the performance, running status or health degree of the resource cluster is associated with multiple influencing factors, among which closely related influencing factors are called key factors herein. For example, the key factors may include: connectivity and bandwidth utilization rate of a public network portal to which the resource cluster is connected; the overall load and the CPU utilization rate (for example, the average value), etc., of respective resources (servers) of the resource cluster; the connectivity and role of services provided by the resource cluster. Therefore, these key factors can be given the highest priority, and after acquiring the indicator data values corresponding to these key factors, if the resource cluster is the concerned resource cluster, it can also show the indicator data values corresponding to these key factors with the highest priority. Or, more generally, all the indicator data values of the concerned resource cluster or a part thereof can be presented.

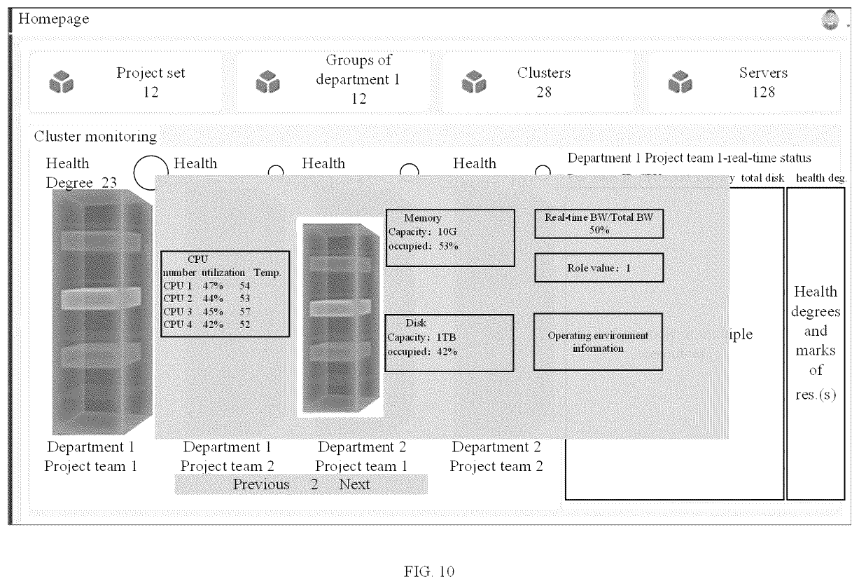

For example, compared with the first display interface shown in FIG. 5, FIG. 10 shows that while the health degrees of multiple resource clusters are being presented on the first display interface, the indicator data values of multiple monitored indicators (e.g., CPU utilization rate, memory capacity and utilization rate, real-time bandwidth/total bandwidth, etc.) for the resource cluster corresponding to project team 1 of department 1 (the health degree thereof is very low, and thus it serves as the concerned resource cluster) are further presented and overlaid on a part of the display region corresponding to the health degrees of the plurality of resource clusters. Optionally, an empty circle in the figure can refer to a mark when the health degree is low, and a solid circle can refer to the position of each resource with a low health degree in the resource cluster. Besides overlapping at least the display region corresponding to the health degrees on the first display interface, the indicator data values of the multiple monitored indicators can also be presented on other display regions of the first display interface and presented in a form of a window. Optionally, the indicator data values of the multiple monitored indicators can be presented on another display interface. For example, if the first display interface is a webpage, the indicator data values of the plurality of monitored indicators can also be presented on a new webpage (regarded as another display interface).

It can be seen that while the health degrees of respective resource clusters can be seen intuitively, the indicator data values corresponding to the key factors for respective resources in the concerned resource cluster can also presented, so as to provide more reference information for the operation and maintenance personnel and flexibly show the user's concerns.

In addition, as mentioned above, an alarm policy can be set for some monitored objects, so that when the indicator data values of these monitored objects meet the alarm policy, an alarm operation can be performed.

Therefore, the method can also include step S940. In step S940, in response to an indicator data value of a certain monitored indicator of a certain monitored object meeting an alarm trigger condition, alarm details are presented on a second display interface, where the alarm details at least include an expression of the alarm trigger condition, the indicator data value meeting the alarm trigger condition and related information of the certain monitored object.

For example, the alarm policy can be configured on the configuration interface as shown in FIG. 3 for important indicators of some important resources. The second display interface that presents the alarm details can be as shown in FIG. 4, and the monitored object can be a resource cluster which is filtered by the resource label and includes multiple resources. For example, when the indicator data values that meet the alarm trigger condition are presented in a form of list, the indicator data values at multiple time points when the alarm event occurs during a statistical period can be presented according to a time sequence that the alarm trigger condition is met (that is, the alarm event occurs) (for example, the overall CPU utilization rate of the resource cluster is greater than 85% within the statistical period (for example, 60 s)). When presenting the indicator data values that meet the alarm trigger conditions in a form of chart, the indicator data values in multiple statistical periods can be presented according to a time line, and a reminder mark (for example, a vertical dotted line) can be presented at the time point when the alarm event occurs for the first time.

In addition, as mentioned above, it is possible to monitor the indicator data values of certain monitored indicators for certain monitored objects within a predetermined time period, so the method can also include step S950. In step S950, in response to a first interface switching event, a third display interface for a user to input a desired monitored indicator, a desired monitored object and a desired time period is presented, and in response to input information for the desired monitored indicator, the desired monitored object and the desired time period, indicator data values of the desired monitored indicator of the desired monitored object within the desired time period are presented on the third display interface or another display interface.

Optionally, this step can be executed by the picture viewing module in the presentation management module, the user-and-resource management module and the data acquisition module mentioned above. Alternatively, the desired monitored object can be a resource, a resource cluster or a service.

For example, the first interface switching event may be that a user's selection operation for an icon related to viewing picture is received. The third display interface may be the picture viewing display interface shown in FIG. 6. For example, based on the input information for the desired monitored indicator, the desired resource label and the desired time period, the indicator data values of the desired monitored indicator of resources corresponding to the desired resource label within the desired time period can be presented on the picture viewing display interface. For example, as shown in FIG. 6, two curves indicating the memory idle rate (as the desired monitored indicator) of two resources (filtered by the desired resource label) changing with time within the desired time period are shown.

In addition, as mentioned above, the indicator data values of the monitored indicators for a certain monitored object within a predetermined time period can be monitored, so the method can also include step S960. In step S960, in response to a second interface switching event, a fourth display interface for the user to input indication information of a desired monitored object is presented; and in response to the indication information input by the user for the desired monitored object, indicator data values of one or more monitored indicators of the desired monitored object are presented on the fourth display interface or another display interface. For example, the second interface switching event may be a user's selection operation for an icon guiding to view indicator data values of the certain monitored object. Optionally, this step can be executed by the large-cap monitoring module, the data acquisition module, the user and the resource management module in the presentation management module.

In addition, as mentioned above, statistics may be conducted on the indicator data values of various indicators of multiple monitored objects of the network system (for example, resources, resource clusters, services, containers, middleware, etc.) and statistical data can be presented, so the method can further include step S970. In step S970, statistical data of the network system is determined, and the statistical data is presented on the fifth display interface, where the statistical data includes statistical data of a number related to the resources of the network system and statistical data of indicator data values of monitored indicators of the monitored object included in the network system. Optionally, this step can be executed by the large-screen presentation management module, the user-and-resource management module, and the data acquisition module in the presentation management module as mentioned above.

For example, the fifth display interface may be the statistical data display interface shown in FIG. 8. Statistical data can include: a total number of projects in the last six months and a number of projects in each month, a total number of resource clusters in the last six months and a number of resource clusters in each month, a number of servers under each project at present, a total number of servers, a number of projects at present, a number of resource clusters at present, an overall CPU utilization rate at each of recent multiple time points, an overall memory utilization rate at each of recent multiple time points and an overall disk utilization rate at each of recent multiple time points. Of course, the contents of the statistical data can be preset, and types of the pieces of statistical data shown in FIG. 8 can be increased, decreased or changed.

It can be seen that through the above additional steps, various indicator data or statistical data of various monitored objects of the network system can be intuitively presented to the user from different perspectives according to their needs, and these data can be presented in a form of report form to improve readability.

In the aforementioned health degree management module, it is necessary to calculate the health degree of the monitored object. Therefore, the calculation process of the health degree will be introduced in detail below.

As mentioned above, the embodiments of the present disclosure may involve various levels of health degree, for example, a comprehensive health degree of the network system, and server cluster (i.e., resource cluster) health degree, server (resource) health degree, service health degree, public network portal health degree, etc., which are further detailed. The comprehensive health degree of the network system can be determined based on the service health degree and the public network portal health degree, and the service health degree can be determined based on the server health degree that provides a corresponding service.

Because the performance, running status and health degree of each monitored object (for example, resource, resource cluster, network system, service, public network portal, etc.) depend on corresponding influencing factors, which can be measured by corresponding indicators, the performance, running status and health degree of each monitored object can be determined by collecting the data values of indicators.

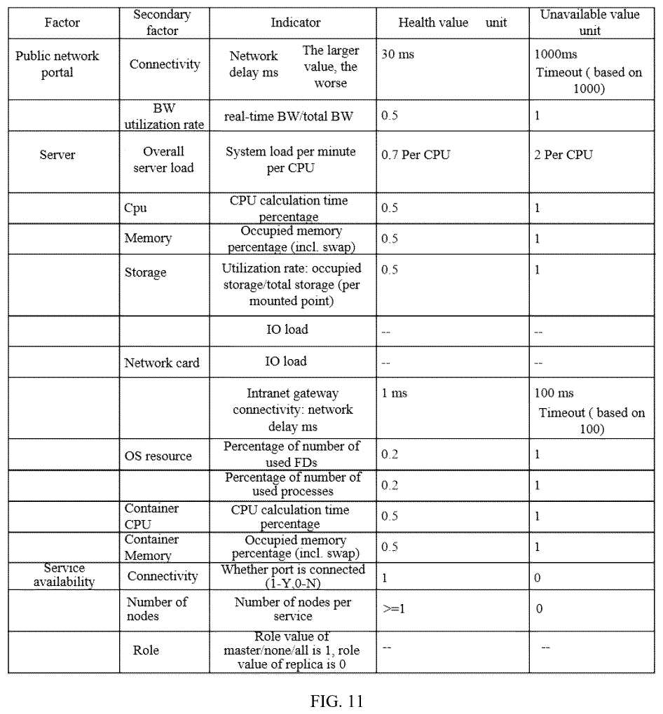

Therefore, the monitored indicators for different monitored objects will be introduced with reference to FIG. 11. Respective monitored indicators shown in FIG. 11 are all the monitored indicators needed to calculate the comprehensive health degree of the network system, and when calculating the health degree of other levels, the required corresponding monitored indicators can also be determined according to FIG. 11.

As shown in FIG. 11, three types of influencing factors of the comprehensive health degree of the network system are shown: a public network portal, server, and service availability. For each type of influencing factors, secondary influencing factors are further set, and each secondary influencing factor corresponds to a monitored indicator.

For example, for the public network portal, two secondary influencing factors, connectivity and bandwidth utilization rate, can be considered, and two monitored indicators, network delay (unit: ms) and real-time bandwidth/total bandwidth, can be set accordingly for these two secondary influencing factors. In FIG. 11, the monitored indicators for the server and service availability are also set in a similar way.

In addition, for each monitored indicator, a health value and an unavailable value are also set, where the health value can indicate that the monitored object is healthy for the monitored indicator if the indicator data value of the monitored indicator is less than or equal to the health value, and the unavailable value is used for subsequent health degree calculation. In addition, for the setting of monitored indicators under the same type of influence factors, with the increase or decrease of the indicator data value of each monitored object, the same trend is indicated. For example, indicator data values of the monitored indicators (for example, a percentage of occupied memory, a percentage of CPU calculation time, etc.) under the condition that the influence factor is the server increase, the health degree of the server decreases. The range of health value and the range of the unavailable value for each monitored indicator are adjustable, which can be comprehensively considered according to the importance of the actual network system, the tolerance of users and the cost.

In addition, when it is necessary to determine the health degree of a single server, respective monitored indicators corresponding to the secondary impact factors of the server in FIG. 11 can be set. When it is necessary to determine the health degree of a server cluster, it can be obtained based on the health degree of each server included in the server cluster, so it is actually obtained based on respective monitored indicators corresponding to the secondary impact factors of the server in FIG. 11. When it is necessary to determine the health degree of a service, it can be obtained based on the health degree of each server included in the server cluster that provides the service, so it is also necessary to set respective monitored indicators corresponding to the secondary impact factors of the server and monitored indicators respectively related to connectivity and a number of nodes for the service, as shown in FIG. 11.

After explaining the monitored indicators that need to be set when calculating different levels of health degree based on FIG. 11, the specific calculation process is introduced below.

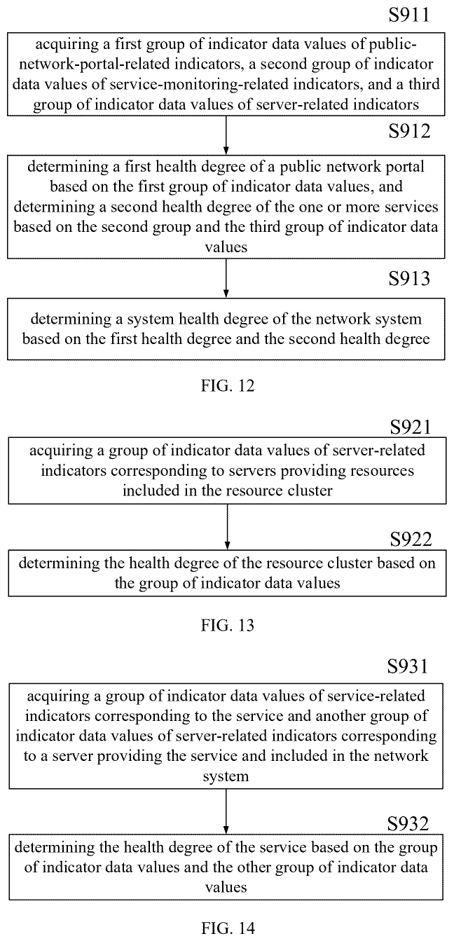

When calculating the comprehensive health degree of the network system, that is, the monitored object is the network system, as shown in FIG. 12, the method 900 may further include the following steps of calculating the health degree. These steps can be performed by the health degree management module in FIG. 1. Moreover, after the user-and-resource management module has grouped the network system, the health degree management module can also know the resource grouping information.

In step S911, a first group of indicator data values of public-network-portal-related indicators corresponding to a public network to which the network system is connected, a second group of indicator data values of service-monitoring-related indicators corresponding to one or more services provided by the network system, and a third group of indicator data values of server-related indicators corresponding to servers included in the network system can be acquired.

In step S912, a first health degree of a public network portal can be determined based on the first group of indicator data values, and a second health degree of the one or more services can be determined based on the second group of indicator data values and the third group of indicator data values.

In step S913, the system health degree of the network system may be determined based on the first health degree and the second health degree.

For example, as previously described with reference to FIG. 11, the public-network-portal-related indicators may be defined based on a network connectivity and/or a bandwidth utilization rate, and exemplary indicators are shown as network delay and real-time bandwidth/total bandwidth in FIG. 11, so that the health degree management module can determine the first health degree of the public network portal after obtaining the indicator data value of network delay and the indicator data values of real-time bandwidth and total bandwidth (e.g., the ratio of real-time bandwidth to total bandwidth can be further calculated by the health degree management module) from the data acquisition module.

More specifically, the first health degree of the public network portal can be determined by the following formula (1):

$$min [ ( 1 - DET 1 / UNA 1 ) , ( 1 - DET 2 / UNA 2 ) ] , \qquad ( 1 )$$

where min ( ) is a function to take the minimum value, DET 1 is the monitored network delay value 1, UNA 1 is the unavailable value of the network delay shown in FIG. 11, DET 2 is the ratio of the monitored real-time bandwidth to the monitored total bandwidth, and UNA 2 is the unavailable value of the ratio of real-time bandwidth to total bandwidth. If DET 1/UNA 1 or DET 2/UNA 2 is greater than 1, take 1.

Alternatively, the first health degree can also be determined based on the average value or other operational values of the two indicator data values.

For another example, combined with FIG. 11, the health degree of a single service among the one or more services provided by the network system can be determined based on the health degree of the server(s) providing the service and the indicator data value of the service-related indicator, and the health degree of the server is determined based on the indicator data value of the server-related indicator(s). Service-related indicators are defined based on at least one of port connectivity, a number of nodes of a single service, and a role, and exemplary indicators are shown in FIG. 11.

More specifically, for example, the health degree SEV i of a single service i can be determined by the following formula (2):

$$SEV i = sum ( whether the port is connected * role value * health degree of the server s ) / the number of nodes \qquad ( 2 )$$

where sum ( ) is a summation function, i is an integer greater than or equal to 1, s is an integer greater than or equal to 1 and less than or equal to p, p is a number of servers providing the single service. In addition, the value is 1 if the port is connected, and the value is 0 if the port is not connected. If the role is master/none/all, the role value is 1, and if it is replica, the role value is 0. The number of nodes is the number of replicas of the service. Since a single service may be provided by multiple servers, after the health degrees of p servers are obtained respectively, they are brought into the formula (2) to sum the obtained values to obtain the health degree of the single service i.

Therefore, after determining the health degree of a single service, the health degree SSEV of the services provided by the network system (a second health degree) can be determined by formula (3):

$$SSEV = min ( SEV 1 , SEV 2 , … , SEV N ) \qquad ( 3 )$$

where min ( ) is a function to take the minimum value, and N is the number of services provided by the network system, that is to say, the health degree of the services provided by the network system is the minimum value among the health degrees of all the services provided by the network system.

Alternatively, the average, median or other operational values of the health degrees of all services provided by the network system can also be used as the second health degree.

In addition, the server health degree reflects an adequacy of server resources, a busyness of the server, and a network connectivity between the server and its associated servers. It is designed to be in the range of 0˜1, and the greater the value, the healthier it is.

Regarding the calculation process of the server health degree, for each server, a group of indicator data values of server-related indicators corresponding to the server are acquired, and then the server health degree is determined based on the group of indicator data values.

With reference to FIG. 11, the server-related indicators can be defined based on at least one of: overall server load, a central processing unit (CPU), memory, storage capacity, operating system resources, onboard container CPU or onboard container memory, and exemplary indicators are shown in FIG. 11.

For example, the health degree SEVER i of a single server i can be determined by the following formula (4):

$$SEVER i = min [ ( 1 - DET j / UNA j ) , 1 ⩽ j ⩽ M ] \qquad ( 4 )$$

where min ( ) is a function to take the minimum value, M is the number of server-related indicators, DET j is the monitored indicator data value of the server-related indicator j, and UNA j is the unavailable value of the server-related indicator j. If DET j/UNA j is greater than 1, take 1.

Alternatively, the average value, median value or other operational values of the values (1−DET j/UNA j) calculated for respective server-related indicators can also be taken as the health degree SEVER i of the single server i.

In this way, after the health degree of each server is calculated, it can be brought into the formula (3), so that the second health degree of the services provided by the network system can be obtained.

Therefore, after both the first health degree and the second health degree are calculated, the comprehensive health degree SC of the network system can be determined by formula (5), for example:

$$SC = min ( first health degree , second health degree ) \qquad ( 5 )$$

where min ( ) is a function to take the minimum value.

On the other hand, when calculating the health degree of the resource cluster included in the network system, that is, the monitored object is at least one resource cluster included in the network system, as shown in FIG. 13, the method 900 may further include the following steps of calculating the health degree. These steps can be performed by the health degree management module in FIG. 1 and for each resource cluster.

In step S921, a group of indicator data values of server-related indicators corresponding to servers providing resources included in the resource cluster are acquired.

In step S922, the health degree of the resource cluster is determined based on the group of indicator data values.

For example, the resource cluster may be a group of resources of a same organization (for example, a same project team in a same department), or a group of resources filtered by a resource label (for example, for providing the same service). The resources in the resource cluster may be provided by multiple servers, so the health degree of the resource cluster can be regarded as the comprehensive health degree of all servers providing resources in the resource cluster.

For example, when calculating the health degree of the resource cluster, the health degree of each server may be calculated first according to the previous formula (4), and then take the minimum value or average value or other operational values of the health degrees of all servers as the health degree of the resource cluster. When the resource cluster is used to provide the same service, the determination process is equivalent to the above determination process of the health degree of a single service.

On the other hand, when calculating the health degree of one or more services provided by the network system, that is, the monitored object is the one or more services provided by the network system, as shown in FIG. 14, the method 900 may further include the following steps of calculating the health degree. These steps can be performed by the health degree management module in FIG. 1 and for each service.

In step S931, a group of indicator data values of service-related indicators corresponding to the service and another group of indicator data values of server-related indicators corresponding to servers providing the service in the network system are obtained.

In step S932, the health degree of the service is determined based on the group of indicator data values and the other group of indicator data values.

For example, the health degree of a single service can be calculated by combining the previous formula (2) and formula (4). More details are similar to those before, so the description will not be repeated here.

Similarly, when the monitored object is one or more resources provided by the network system, for each resource, the health degree of the server providing the resource can also be determined based on a group of indicator data values of the server-related indicators corresponding to the server providing the resource.

The following describes the calculation process of the comprehensive health degree of the network system in combination with the specific indicator data values of the collected indicators.

FIG. 11 shows a table of specific sampled indicator data values of respective indicators.

According to the indicator data values in the table shown in FIG. 14, the health degree of the public network portal can be calculated as 0.4 according to formula (1), and the health degrees of respective servers (1-9) can be calculated as 0.7, 0, 0, 0.1, 0.4, 0, 0.1, 0 and 0.5 respectively according to formula (4). The network system provides three services, and according to formulas (2) and (3) and in combination with the health degree of each server, it is calculated that the health degree of services provided by the network system is min (0, 0.025, 0.25), that is, the health degree of services is 0. Then, according to formula (5), it is determined that the comprehensive health degree of the network system is min (0.7, 0), which is 0, indicating that the system is very unhealthy.

As mentioned above, it may be necessary to use the unavailable value of a corresponding indicator when calculating the health degree, and the unavailable value can be modified to meet various needs and facilitate the setting by the user according to the needs such as concerns on clusters, roles, servers. For example, the presentation management module can present a configuration interface on the display screen, which is used to receive user's input information to configure or modify the health values and unavailable values of these monitored indicators, and to set or modify the presentation priority of secondary factors corresponding to each indicator. When the health degree of a resource cluster does not meet the condition, the indicator data values of these indicators (indicators corresponding to key factors) of the resource cluster are presented on the display interface, as shown in FIG. 10.

After calculating the health degree, the corresponding RGB values can be determined based on the health degree, and then the current health degree can be presented in the color corresponding to the determined RGB values. For example, the health degree SA obtained by the above calculation process is a value between 0 and 1, and the presented color can be based on RGB (255*(1−SA), 255*SA, 0).

To sum up, the calculation method for the health degree for different monitored objects is described in combination with FIG. 11 to FIG. 14, which can present different levels of health degrees, such as system health degree, resource cluster health degree, service health degree, etc., thus realizing the local perspectives and global perspective of monitoring the system, and because the health degree can reflect the availability of network system and various resources and the service quality, it can avoid over-processing or delayed processing.

According to another aspect of the present disclosure, the invention also provides a device for monitoring a network system.

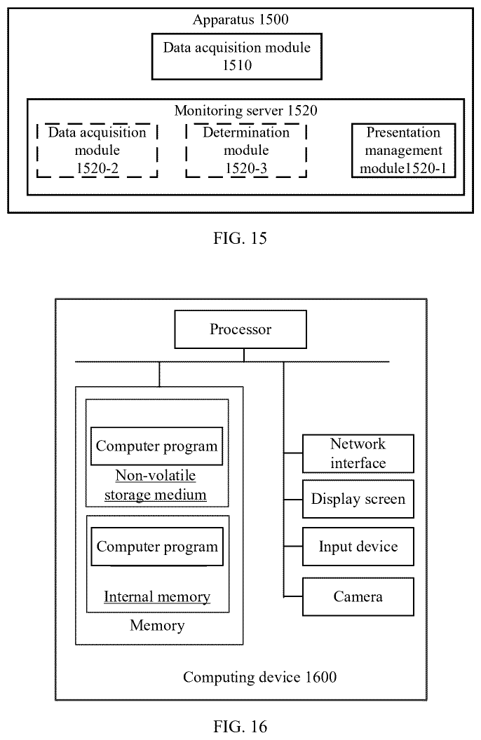

FIG. 15 shows a structural block diagram of an apparatus 1500 according to the embodiments of the present disclosure. The apparatus 1500 may be the monitoring platform shown in FIG. 1.

As shown in FIG. 15, the apparatus 1500 may include a data acquisition module 1510 and a monitoring server 1520. The data acquisition module 1510 can be used to collect various indicator data from a network system and a public network, for example, the indicator data related to the health degree of the monitored object, and the monitoring server can obtain various indicator data from the data acquisition module 1520, and perform processing, analysis, calculation, presentation, etc. for the various indicator data.

The data acquisition module 1510 may include at least a part of a storage device (e.g., a memory), a processor, a plug-in, an interface, a program, and the like.

The monitoring server 1520 may be the monitoring server in the monitoring platform described in FIG. 1-FIG. 8.

Further, as shown in FIG. 15, the monitoring server 1500 may include a presentation management module 1520-1, which is used to present a health degree of a monitored object on a first display interface in response to a health degree presentation trigger event, where different health degrees correspond to different marks, and the monitored object includes at least one of the following: the network system including at least one resource cluster, one or more resource clusters among the at least one resource cluster, one or more resources included in the network system, or one or more services provided by the network system.

Optionally, the presentation management module 1520-1 is further configured to present health degrees of one or more resource clusters in the at least one resource cluster on the first display interface, and at the same time, present health degrees of respective resources included in a concerned resource cluster in the one or more resource clusters with the different marks on the first display interface or another display interface.

Optionally, the monitoring server 1520 may further include a data acquisition module 1520-2 and a determination module 1520-3 (for example, the aforementioned health degree management module).

When the monitored object is the network system, the data acquisition module 1520-2 may be configured to acquire a first group of indicator data values of public-network-portal-related indicators corresponding to a public network to which the network system is connected, a second group of indicator data values of service-monitoring-related indicators corresponding to the one or more services provided by the network system, and a third group of indicator data values of server-related indicators corresponding to servers included in the network system. The determination module 1520-3 may be configured to determine a first health degree of a public network portal based on the first group of indicator data values, determine a second health degree of the one or more services based on the second group of indicator data values and the third group of indicator data values; and determine a system health degree of the network system based on the first health degree and the second health degree.

When the monitored object is the at least one resource cluster included in the network system, the data acquisition module 1520-2 may be configured to: for each resource cluster of the at least one resource cluster, acquire a group of indicator data values of server-related indicators corresponding to servers providing resources included in the resource cluster, and determine the health degree of the resource cluster based on the group of indicator data values, and the determination module 1520-3 may be configured to determine the health degree of each resource cluster based on the group of indicator data values for each resource cluster in the at least one resource cluster.

When the monitored object is the one or more services provided by the network system, the data acquisition module 1520-2 may be configured to: for each service of the one or more services, acquire a group of indicator data values of service-related indicators corresponding to the service and another group of indicator data values of server-related indicators corresponding to a server providing the service and included in the network system, and the determination module 1520-3 may be configured to determine the health degree of each service of the one or more services based on the group of indicator data values and the other group of indicator data values for the service.

When the monitored object is the one or more resources provided by the network system, the data acquisition module 1520-2 may be configured to: for each resource of the one or more resources, acquire a group of indicator data values of server-related indicators corresponding to a server providing the resource, and the determination module 1520-3 may be configured to determine, for each resource of the one or more resources, the health degree of the server providing the resource based on the group of indicator data values.

Optionally, the public-network-portal-related indicators are defined based on a network connectivity and/or a bandwidth utilization rate, the server-related indicators are defined based on at least one of: server overall load, a central processing unit (CPU), a memory, a storage capacity, operating system resources, onboard container CPU and onboard container memory, and/or the service-related indicators are defined based on at least one of: port connectivity, a number of nodes of a single service, or role.

As described above with reference to FIG. 1 to FIG. 8, the apparatus 1500 or the monitoring server 1520 may further include other modules, such as an alarm management module, which is used to present alarm details on a second display interface in response to an indicator data value of a monitored indicator of a certain monitored object meeting an alarm trigger condition, where the alarm details at least include an expression of the alarm trigger condition, the indicator data value meeting the alarm trigger condition and related information of the monitored object.

For more details of the apparatus 1500, please refer to the previous description of the monitoring platform, so it will not be repeated here.

By referring to the device for monitoring the network system described in FIG. 15, different contents are presented by the presentation management module, and the concept of different levels of health degree is also put forward, which can intuitively provide the indication of the performance, running status or health degree of the network system, resources, resource clusters or services from the perspective of end users, and realize the monitoring of the network system from a local perspective and a global perspective.

According to another aspect of the present disclosure, a computing device is also provided. The computing device may reside on the monitoring platform shown in FIG. 1-FIG. 8, for example, as a monitoring server on the monitoring platform.

FIG. 16 shows a schematic block diagram of a computing device 1600 according to an aspect of the present disclosure.

As shown in FIG. 16, the computing device 1600 may include one or more processors, one or more memories, and optionally a network interface, an input device, and a display screen. Each memory comprises a non-volatile storage medium and an internal memory. The non-volatile storage medium of the computing device stores an operating system, and may also store a computer program, which, when executed by the processors, can cause the processors realize various operations described in the aforementioned steps. The internal memory can also store a computer program which, when executed by the processors, can cause the processors to perform various operations described in the aforementioned steps.

Each processor can be an integrated circuit chip with signal processing capability. The processor can be a general processor, a digital signal processor (DSP), an application specific integrated circuit (ASIC), an off-the-shelf programmable gate array (FPGA) or other programmable logic devices, discrete gate or transistor logic devices, and discrete hardware components, which can be used to implement or execute the methods, steps and logic blocks disclosed in the embodiments of the present disclosure. The general processor can be a microprocessor or any conventional processor, and it can be of X84 architecture or ARM architecture.

The non-volatile memory may be read-only memory (ROM), programmable read-only memory (PROM), erasable programmable read-only memory (EPROM), electrically erasable programmable read-only memory (EEPROM) or flash memory. It should be noted that the memory for implementing the methods described in the present disclosure is intended to include, but is not limited to, these and any other suitable types of memories.

The display screen of the computing device 1600 can be a liquid crystal display screen or an electronic ink display screen, and the input device of the computing device can be a touch layer covered on the display screen, a button, a trackball or a touchpad arranged on a terminal shell, and an external keyboard, touchpad or mouse.

The computing device 1600 may be a server. The server can be a cloud server, that is, an independent server, a server cluster or a distributed system composed of multiple servers, and can provide basic cloud computing services such as cloud service, cloud database, cloud computing, cloud function, cloud storage, network service, cloud communication, middleware service, domain name service, security service, CDN, big data and artificial intelligence platform.

According to another aspect of the present disclosure, there is also provided a computer-readable storage medium storing a computer program, which, when executed by a processor, causes the processor to perform the steps of the method as described above.

According to yet another aspect of the present disclosure, there is also provided a computer program product, including a computer program, which, when executed by a processor, causes the processor to perform the steps of the method as described above.

Although the present disclosure has been described in detail with respect to various specific example embodiments thereof, each example is provided by way of explanation rather than limitation. Those skilled in the art can easily make alterations, variations and equivalents of such embodiments after gaining an understanding of the above. Therefore, the present invention does not exclude such modifications, changes and/or additions to the present disclosure that will be obvious to those skilled in the art. For example, features illustrated or described as part of one embodiment may be used with another embodiment to produce yet another embodiment. Therefore, it is intended that this disclosure cover such alterations, variations and equivalents.

In particular, although the drawings of the present disclosure respectively describe the steps performed in a specific order for purposes of illustration and discussion, the method of the present disclosure is not limited to the illustrated specific order or arrangement. Without departing from the scope of the present disclosure, various steps of the above method may be omitted, rearranged, combined and/or adjusted in various ways.

Those skilled in the art can understand that various aspects of the present disclosure can be illustrated and described by several patentable categories or situations, including a combination of any new and useful process, machine, product or substance, or any new and useful improvement on them. Accordingly, various aspects of the present disclosure can be completely executed by hardware, completely executed by software (including firmware, resident software, microcode, etc.), or executed by a combination of hardware and software. All the above hardware or software can be called “block”, “module”, “engine”, “unit”, “component” or “system”. Furthermore, aspects of the present disclosure may be embodied as a computer product in one or more computer-readable media, which includes computer-readable program code.

The above is an explanation of the present disclosure and should not be considered as a limitation. Although several exemplary embodiments of the present disclosure have been described, those skilled in the art will easily understand that many modifications can be made to the exemplary embodiments without departing from the novel teaching and advantages of the present disclosure. Therefore, all such modifications are intended to be included within the scope of this disclosure as defined by the claims. It should be understood that the above is an explanation of the present disclosure and should not be considered as limited to the disclosed specific embodiments, and modifications to the disclosed embodiments and other embodiments are intended to be included within the scope of the appended claims. The present disclosure is defined by the claims and their equivalents.

1. A method for monitoring a network system including at least one resource cluster, the method comprising:
presenting, in response to a health degree presentation trigger event, a health degree of a monitored object on a first display interface, wherein different health degrees correspond to different marks,
wherein, the monitored object includes at least one of: the network system, one or more resource clusters among the at least one resource cluster, one or more resources included in the network system, or one or more services provided by the network system.

2. The method according to claim 1, further comprising:
presenting, using different marks and on the first display interface or another display interface, health degrees of respective resources included in a concerned resource cluster of one or more resource clusters among the at least one resource cluster, while presenting health degrees of the one or more resource clusters on the first display interface.

3. The method according to claim 2, wherein the concerned resource cluster is a resource cluster whose health degree does not meet a qualification threshold condition among the one or more resource clusters, a resource cluster whose health degree is the lowest among the one or more resource clusters, a resource cluster in which a number of resources whose health degree does not meet the qualification threshold condition exceeds a quantity threshold, or a resource cluster determined in response to a user's selection.

4. The method according to claim 2, wherein the health degree of each monitored object is associated with one or more monitored indicators, and
wherein the method further comprises:
presenting indicator data values of the one or more monitored indicators for the resources included in the concerned resource cluster at least on the first display interface or on another display interface, while presenting the health degrees of the one or more resource clusters.

5. The method according to claim 1, wherein the health degree of each monitored object is associated with one or more monitored indicators,
the method further comprises:
presenting, in response to an indicator data value of a certain monitored indicator of a certain monitored object meeting an alarm trigger condition, alarm details on a second display interface,
wherein, the alarm details include at least: an expression of the alarm trigger condition, the indicator data value meeting the alarm trigger condition and related information of the certain monitored object.

6. The method according to claim 1, wherein the at least one resource cluster is obtained by grouping resources included in the network system, and resources included in each resource cluster have a same resource label, belong to a same organization, or have a same operating environment.

7. The method of claim 1, further comprising:
presenting, in response to a first interface switching event, a third display interface for a user to input indication information for indicating a desired monitored indicator, a desired monitored object and a desired time period; and
presenting, on the third display interface or another display interface and in response to the indication information input by the user, indicator data values of the desired monitored indicator of the desired monitored object within the desired time period.

8. The method of claim 1, further comprising:
presenting, in response to a second interface switching event, a fourth display interface for a user to input indication information for indicating a desired monitored object; and
presenting, on the fourth display interface or another display interface and in response to the indication information input by the user, indicator data values of one or more monitored indicators of the desired monitored object.

9. The method of claim 1, further comprising:
determining statistical data of the network system, and presenting the statistical data on a fifth display interface,
wherein, the statistical data includes statistical data of a number related to the resources of the network system and statistical data of indicator data values of monitored indicators of the monitored object included in the network system.

10. The method according to claim 1, wherein the monitored object is the network system, and
wherein the method further comprises:
acquiring a first group of indicator data values of public-network-portal-related indicators corresponding to a public network to which the network system is connected, a second group of indicator data values of service-monitoring-related indicators corresponding to the one or more services provided by the network system, and a third group of indicator data values of server-related indicators corresponding to servers included in the network system;
determining a first health degree of a public network portal based on the first group of indicator data values, and determining a second health degree of the one or more services based on the second group of indicator data values and the third group of indicator data values; and
determining a system health degree of the network system based on the first health degree and the second health degree.

11. The method according to claim 1, wherein the monitored object is the at least one resource cluster included in the network system, and
wherein the method further comprises: for each resource cluster of the at least one resource cluster,
acquiring a group of indicator data values of server-related indicators corresponding to servers providing resources included in the resource cluster; and
determining the health degree of the resource cluster based on the group of indicator data values.

12. The method according to claim 1, wherein the monitored object is the one or more services provided by the network system, and
wherein the method further comprises: for each service of the one or more services,
acquiring a group of indicator data values of service-related indicators corresponding to the service and another group of indicator data values of server-related indicators corresponding to a server providing the service and included in the network system; and
determining the health degree of the service based on the group of indicator data values and the other group of indicator data values.

13. The method according to claim 1, wherein the monitored object is the one or more resources provided by the network system, and
wherein the method further comprises: for each resource in the one or more resources,
acquiring a group of indicator data values of server-related indicators corresponding to a server providing the resource; and
determining the health degree of the server providing the resource based on the group of indicator data values.

14. (canceled)

15. The method according to claim 1, wherein the different marks are different colors, and
where the method further comprises:
determining RGB values based on a current health degree of the monitored object to be presented; and
presenting the current health degree with a color corresponding to the determined RGB values.

16. An apparatus for monitoring a network system including at least one resource cluster, the apparatus comprising:
a data acquisition module configured to acquire, from the network system and a public network to which the network system is connected, various indicator data related to a health degree of a monitored object;
a monitoring server, comprising:
a presentation management module configured to present, in response to a health degree presentation trigger event, the health degree of the monitored object on a first display interface, wherein different health degrees correspond to different marks,
wherein, the monitored object includes at least one of: the network system, one or more resource clusters among the at least one resource cluster, one or more resources included in the network system, or one or more services provided by the network system.

17. The apparatus according to claim 16, wherein the presentation management module is further configured to present, using different marks and on the first display interface or another display interface, health degrees of respective resources included in a concerned resource cluster of one or more resource clusters among the at least one resource cluster, while presenting health degrees of the one or more resource clusters on the first display interface.

18. (canceled)

19. The apparatus according to claim 16, wherein the monitored object is the network system, and
wherein the monitoring server further comprises:
a data acquisition module, configured to obtain a first group of indicator data values of public-network-portal-related indicators corresponding to the public network to which the network system is connected, a second group of indicator data values of service-monitoring-related indicators corresponding to the one or more services provided by the network system, and a third group of indicator data values of server-related indicators corresponding to servers included in the network system; and
a determination module, configured to: determine a first health degree of a public network portal based on the first group of indicator data values, and determine a second health degree of the one or more services based on the second group of indicator data values and the third group of indicator data values; and determine a system health degree of the network system based on the first health degree and the second health degree.

20. The apparatus according to claim 16, wherein the monitored object is the at least one resource cluster included in the network system, and
wherein the monitoring server further comprises:
a data acquisition module configured to acquire, for each resource cluster of the at least one resource cluster, a group of indicator data values of server-related indicators corresponding to servers providing resources included in the resource cluster; and
a determination module configured to determine, for each resource cluster of the at least one resource cluster, the health degree of the resource cluster based on the group of indicator data values.

21. The apparatus according to claim 16, wherein the monitored object is the one or more services provided by the network system, and
wherein the monitoring server includes:
a data acquisition module configured to acquire, for each service of the one or more services, a group of indicator data values of service-related indicators corresponding to the service and another group of indicator data values of server-related indicators corresponding to a server providing the service and included in the network system; and
a determination module, configured to determine, for each service of the one or more services, the health degree of the service based on the group of indicator data values and the other group of indicator data values.

22. A computing device comprising:
one or more processors,
one or more memories having stored thereon a computer program which, when executed by the one or more processors, can cause the one or more processors to implement the steps of the method as claimed in claim 1.
